(19) United States
(12) Patent Application Publication
(10) Pub. No.: US 2008/0076369 A1
(43) Pub. Date: Mar. 27, 2008

(54) Transmission Interface Device

(76) Inventor: Chih-Hung Liao, Taipei (TW)

Correspondence Address: HDSL, 4331 STEVENS BATTLE LANE, FAIRFAX, VA, 22033, US

(21) Appl. No.: 11/533,868

(22) Filed: Sep. 21, 2006

(51) Int. Cl. H04B 1/18

(52) U.S. Cl. 455/187.1

(57) ABSTRACT

A transmission interface device includes at least an input port, an output port and a data conversion unit. The input port is used to connect to a handset, the output port is used to connect to a display apparatus, and the data conversion unit is used for converting data formats so that the content on the handset to display may be converted and displayed on the display apparatus. Thus, if necessary, the user may connect the handset to the transmission interface device, which, in turns, is connected to the large-scale display apparatus, and thereby facilitates viewing of pictures.

### BACKGROUND OF THE INVENTION

1. Field of the Invention

The present invention relates to a transmission interface device and, particularly, to a transmission interface device for the user to view graphs and images at any time or to brief in real time.

2. Descriptions of the Related Art

Owing to the popularization of technology, various electronic products provided with powerful functions have gone deep into the core of human life as an indispensable part. Among others, the carry-on products, e.g., handsets such as mobile phones and PDAs (personal digital assistant), is in the main stream. Such handsets are convenient to carry and also can be connected to remote sites through telephone or networks, so that they have broad application. Moreover, the functions of the camera and video camera have become the basic functions, besides the intrinsic ones, of the handsets gradually.

For businesspersons, the handsets may be connected on line to the personnel of a remote companies or a groups synchronously, to get desired data or to change data for business. However, in consideration of handiness and convenience, the handsets are not as good as detached displays, e.g., screens of computers or televisions, with respect to size, color, brightness and resolution. Therefore, the display screens of the mobile phones are provided only for individuals to roughly browse graphs or videos, but not suitable for exhibiting or briefing. In case that the user has to explain to some other persons, preparation of computer and projectors is required. Thus, it is still insufficient for the mobile phones in use.

Further, whether he is a professional or a non-professional, pictures may be captured with the camera of a handset at any time. But, as stated above, he cannot browse the obtained images correctly and must watch them with a computer when getting back to home, so that he may miss a lot of memories.

In view of this, the inventor(s) conceived a solution, in the hope that the content of data on handsets can be viewed on large-scale display apparatuses synchronously. The transmission interface device of the present invention has been ultimately developed through a long-term development and practice.

### SUMMARY OF THE INVENTION

It is a primary objective of this invention to provide a transmission interface device for the user to apply local display apparatuses at any time to display the information in handsets such as mobile phones and PDAs so as to facilitate viewing or briefing.

It is another objective of this invention to provide a transmission interface device that may be connected to large-scale display apparatuses and, thereby, the user may have the graphs and images in handsets made beauty and correct positively and get the graphs and images afresh with the handsets.

It is a further objective of this invention to provide a transmission interface device for image synchronization between the display screens of large-scale display apparatuses and handsets so that the user may operate the handsets at work and view the result on the display apparatuses in real time.

The present invention provides a transmission interface device, the transmission interface device comprising at least an input port, an output port and a data conversion unit, wherein the input port is used to connect to a handset, said handset being a mobile phone or a PDA with function keys and a display screen; the output port is used to connect to a display apparatus, e.g., a television screen or a computer screen, for displaying the data transmitted by the handset; and the data conversion unit is used for converting data formats so that the content on the handset to display may be converted and displayed on the display apparatus.

A transmission interface device fulfilling the objectives described above comprises at least an input port, an output port and a data conversion unit, wherein the input port is used to connect to a handset, the output port is used to connect to a display apparatus, and the data conversion unit is used for converting data formats so that the content on the handset to display may be converted and displayed on the display apparatus. The input port and the output port may be of arbitrary types of wired or wireless headers for facilitating connection and transmission. Thus, if need be, the user may connect the handset to the transmission interface device, which, in turns, is connected to the large-scale display apparatus, and thereby facilitates viewing of pictures. Also, the user may operate the function keys of the handset to have the pictures on the display screen of the handset synchronously displayed on the large-scale display apparatus. Also, the transmission interface device may be directly built in the handset for the convenience of carrying and connecting to suitable display apparatuses for use at any time.

### BRIEF DESCRIPTION OF THE DRAWINGS

The drawings disclose an illustrative embodiment of the present invention, which serves to exemplify the various advantages and objects hereof, and are as follows:

FIG. 1 is a diagram of one embodiment of the present invention;

FIG. 2 is an exemplifying diagram showing a varied structure of the embodiment in FIG. 1; and

FIG. 3 is a diagram of another embodiment of the present invention.

### DESCRIPTION OF THE PREFERRED EMBODIMENT

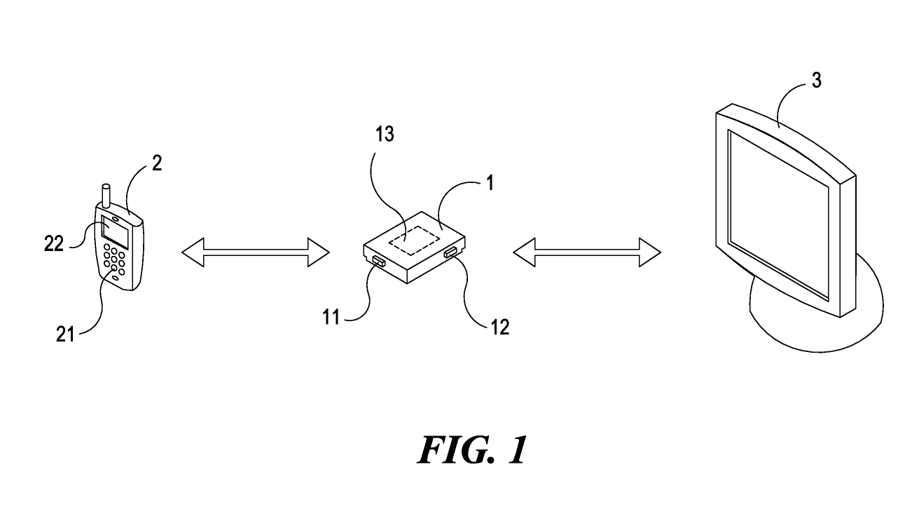

Refer to FIG. 1. The present invention provides a transmission interface device 1, the transmission interface device 1 comprises at least an input port 11, an output port 12 and a data conversion unit 13, wherein the input port 11 is used to connect to a handset 2, said handset 2 being a mobile phone or a PDA with function keys 21 and a display screen 22; the output port 12 is used to connect to a display apparatus 3, e.g., a television screen or a computer screen, for displaying the data transmitted by the handset 2; and the data conversion unit 13 is used for converting data formats so that the content on the handset 2 to display may be converted and displayed on the display apparatus 3.

Said input port 11 and output port 12 are typically wired headers and adopt arbitrary header specification for wired connection, such as USB (UNIVERSAL SERIAL BUS), IEEE (Institute of Electrical and Electronics Engineers) 1394, Ethernet cable, VGA/TV cable, and those for various headers for mobile phone and displays, or, alternatively, the input port 11 and output port 12 may be wireless headers and adopt 802.11, Blue Tooth, infrared ray or radio wave for wireless connection. Thus, if need be, the user may connect the handset 2 to the transmission interface device 1, which, in turns, is connected to the large-scale display apparatus 3, and thereby the user may operate the function keys 21 of the handset 2 to have the pictures on the display screen 22 synchronously displayed on the large-scale display apparatus 3. Certainly, the user may have the pictures on the display screen 22 and on the display apparatus 3 asynchronously by setting a function of the handset 2, which is not to be given more details herein.

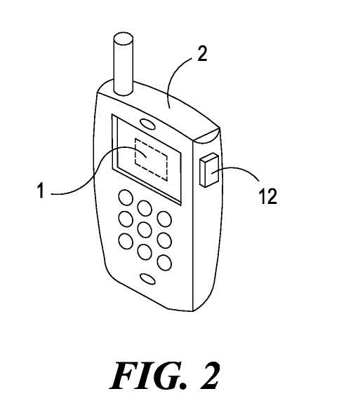

Refer to FIG. 2, which shows that the transmission interface device 1 may be directly built in the handset 2 so that the input port 11 is directly connected into the handset 2 and only the output port 12 is exposed and connected to the display apparatus 3. Thus, as the user carries the handset 2 with him, he carries the transmission interface device 1 as well and has a connection to suitable display apparatuses at any time. It is convenient to carry and easy to use the transmission interface device 1 of the present invention.

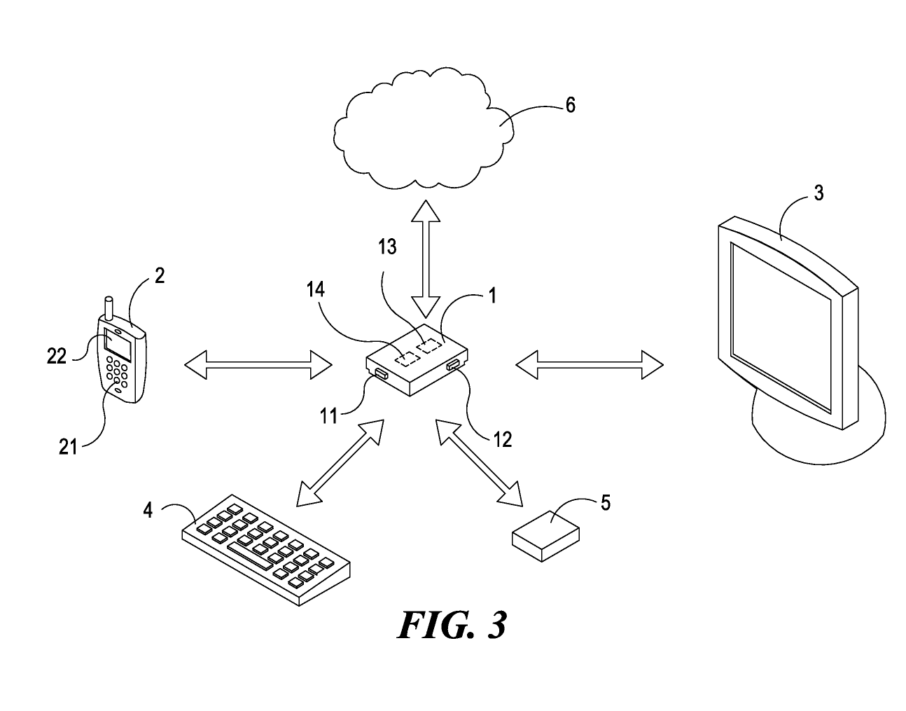

Refer to FIG. 3, which shows that the transmission interface device 1 may have a control unit 14 disposed therein for expanded functions. For example, input devices 4 such as mice and keyboards may be externally connected for replacing the function keys 21 of the handset 2 for smoother operation; storage devices 5 such as hard disks and memory cards may be built in or externally connected for expanding or backuping the data on the handset 2; or external connection to a network 6 may be provided to transmit the data on the handset 2 through the network 6.

Many changes and modifications in the foregoing embodiments of the invention can, of course, be carried out without departing from the scope thereof. Accordingly, to promote the progress in science and the useful arts, the invention is disclosed and intended to be limited only by the scope of the appended claims.

What is claimed is:

1. A transmission interface device comprising at least an input port, an output port and a data conversion unit, wherein the input port is used to connect to a handset, the output port is used to connect to a display apparatus, and the data conversion unit is used for converting the format of data on the handset to display to a format supported by the display apparatus.

2. The transmission interface device of claim 1, wherein the handset is a mobile phone or a PDA.

3. The transmission interface device of claim 1, wherein the input port or the output port are wired headers and adopt USB, IEEE 1394, Ethernet cable or VGA/TV cable for various headers for mobile phones and displays for wired connection.

4. The transmission interface device of claim 1, wherein the input port or output port are wireless headers and adopt 802.11, Blue Tooth, infrared ray or radio wave for wireless connection.

5. The transmission interface device of claim 1, wherein the transmission interface device is built in the handset, with the input port thereof directly connected into the handset.

6. The transmission interface device of claim 1, wherein the transmission interface device has a control unit disposed therein so that input devices can be externally connected for assisting the function of the handset.

7. The transmission interface device of claim 6, wherein the input devices are mice or keyboards.

8. The transmission interface device of claim 1, wherein the transmission interface device has a control unit disposed therein so that storage devices can be built in or externally connected.

9. The transmission interface device of claim 8, wherein the storage devices are hard disks or memory cards

10. The transmission interface device of claim 1, wherein the transmission interface device has a control unit disposed therein so that external connection to a network is provided to transmit data through the network with the handset.
